(19) United States
(12) Patent Application Publication
(10) Pub. No.: US 2026/0195114 A1
(43) Pub. Date: Jul. 9, 2026

(54) METHOD AND SYSTEM TO MANAGE APPLICATIONS ON MULTIPLE HOSTS

(71) Applicant: JPMorgan Chase Bank, N.A., New York, NY (US)

(72) Inventors: Sundeep SAPROO, Hyderabad (IN); Srikanth KONANGI, Pathapatnam (IN); Venugopal SRIDHAR, Hyderabad (IN); Venkataphanimadhur ATHMURI, Hyderabad (IN)

(73) Assignee: JPMorgan Chase Bank, N.A., New York, NY (US)

(21) Appl. No.: 19/057,557

(22) Filed: Feb. 19, 2025

(30) Foreign Application Priority Data
Jan. 7, 2025 (IN) 202511001430

(51) Int. Cl. G06F 8/65; G06F 8/61

(52) U.S. Cl. CPC G06F 8/65; G06F 8/62

(57) ABSTRACT

A method and system to manage applications on multiple hosts are disclosed. The method includes receiving a request to perform at least one task associated with at least one application from a user. The method also includes obtaining, from a server, at least one software package and at least one parameter in response to the request. The method also includes retrieving, from the server, an application to host mapping data based on a type of the at least one application responsive to the request. The method also includes providing the obtained at least one of software package and the at least one parameter to at least one host in accordance with the retrieved application to host mapping data. The method also includes performing, at the at least one host, the at least one task using the obtained at least one software package and the at least one parameter.

### CROSS-REFERENCE TO RELATED APPLICATIONS

This application claims priority benefit from Indian Application No. 202511001430, filed on Jan. 7, 2025 in the India Patent Office, which is hereby incorporated by reference in its entirety.

### FIELD OF THE DISCLOSURE

This technology generally relates to application management, and more particularly relates to a method and system to manage applications on multiple hosts by performing parallel installation of such applications on the multiple hosts using an application to host mapping data.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With advancements in technology, various industries have been adopting automation of tasks using various software applications. Automation has been used by the software industry to boost developer efficiency and enhance the calibre of software. In the evolving landscape of software applications and deployment, effective management of application hosting and installation processes is crucial for optimizing operational efficiency. This is particularly important when dealing with vendor-based applications that require precise configuration and parameterization.

Software applications (also referred to as app or apps) from several vendors are frequently included in modern software ecosystems, each with its specifications and setups. It needs careful planning to match the requirements of such software applications within a host environment to manage the deployment of such apps on hosts. This includes making sure the application runs properly in the intended environment and configuring the necessary parameters for the application. In various computing environments, particularly those involving multiple servers or hosts or cloud-based systems, installation of such software applications often requires mapping of each application to an appropriate host system. This process involves determining which host has the necessary resources, configuration, and compatibility to support the application effectively. Currently, to install the applications on multiple hosts, the user needs to assign different names to the apps to function and for the installation over multiple hosts, such a process happens in a sequential manner which results in extended installation times and increased potential for manual errors. Thus, assigning names to the apps and apps to host mapping is a time-consuming and labour-intensive process.

Hence, in view of these and other existing limitations, there arises an imperative need to provide an efficient solution to overcome the above-mentioned limitations and to provide a method and system to ensure faster installation of applications on multiple hosts.

### SUMMARY

The present disclosure, through one or more of its various aspects, embodiments, and/or specific features or sub-components, provides, inter alias, various systems, servers, devices, methods, media, programs, and platforms to manage applications on multiple hosts.

According to an aspect of the present disclosure, a method to manage applications on multiple hosts is disclosed. The method is implemented by at least one processor. The method includes receiving, by the at least one processor, a request to perform at least one task associated with at least one application from a user. The method also includes obtaining, by the at least one processor from a server, at least one software package and at least one parameter in response to the request. The method also includes retrieving, by the at least one processor from the server, an application to host mapping data based on a type of the at least one application in response to the request. The method also includes providing, by the at least one processor, the obtained at least one software package and the at least one parameter to at least one host in accordance with the retrieved application to host mapping data. The method also includes performing, by the at least one processor at the at least one host, at least one task using the obtained at least one software package and the at least one parameter.

In accordance with an exemplary embodiment, the at least one task corresponds to an installation of the at least one application at the at least one host when the request is received for the installation of the at least one application.

In accordance with an exemplary embodiment, the at least one task corresponds to a modification of the at least one application at the at least one host when the request is received for the modification of the at least one application.

In accordance with an exemplary embodiment, the at least one task corresponds to an uninstallation of the at least one application at the at least one host when the request is received for the uninstallation of the at least one application.

In accordance with an exemplary embodiment, the at least one parameter includes application installation parameters, application modification parameters, and application uninstallation parameters.

In accordance with an exemplary embodiment, the application to host mapping data corresponds to the mapping of at least one from among a single type of application and different type of applications to the at least one host.

According to another aspect of the present disclosure, a computing device configured to implement an execution of a method to manage applications on multiple hosts is disclosed. The computing device includes a processor; a memory; and a communication interface coupled to each of the processor and the memory. The processor may be configured to receive a request from a user to perform at least one task associated with at least one application. The processor may also be configured to obtain, from a server, at least one software package and at least one parameter in response to the request. The processor may also be configured to retrieve, from the server, an application to host mapping data based on a type of the at least one application in response to the request. The processor may also be configured to provide the obtained at least one software package and the at least one parameter to at least one host in accordance with the retrieved application to host mapping data. The processor may be configured to perform, at the least one host, the at least one task using the obtained at least one software package and the at least one parameter.

In accordance with an exemplary embodiment, the at least one task corresponds to an installation of the at least one application at the at least one host when the request is received for the installation of the at least one application.

In accordance with an exemplary embodiment, the at least one task corresponds to a modification of the at least one application at the at least one host when the request is received for the modification of the at least one application.

In accordance with an exemplary embodiment, the at least one task corresponds to an uninstallation of the at least one application at the at least one host when the request is received for the uninstallation of the at least one application.

In accordance with an exemplary embodiment, the at least one parameter includes application installation parameters, application modification parameters, and application uninstallation parameters.

In accordance with an exemplary embodiment, the application to host mapping data corresponds to a mapping of at least one from among a single type of application and different type of applications to the at least one host.

According to yet another aspect of the present disclosure, a non-transitory computer-readable storage medium storing instructions to manage applications on multiple hosts is disclosed. The instructions include executable code which, when executed by a processor, may cause the processor to receive a request from a user to perform at least one task associated with at least one application; obtain, from a server, at least one software package and at least one parameter in response to the request; retrieve from the server, an application to host mapping data based on a type of the at least one application in response to the request; provide the obtained at least one software package and the at least one parameter to at least one host in accordance with the retrieved application to host mapping data; and perform, at the at least one host, the at least one task using the obtained at least one software package and the at least one parameter.

In accordance with an exemplary embodiment, the at least one task corresponds to an installation of the at least one application at the at least one host when the request is received for the installation of the at least one application.

In accordance with an exemplary embodiment, the at least one task corresponds to a modification of the at least one application at the at least one host when the request is received for the modification of the at least one application.

In accordance with an exemplary embodiment, the at least one task corresponds to an uninstallation of the at least one application at the at least one host when the request is received for the uninstallation of the at least one application.

In accordance with an exemplary embodiment, the at least one parameter includes application installation parameters, application modification parameters, and application uninstallation parameters.

In accordance with an exemplary embodiment, the application to host mapping data corresponds to the mapping of at least one from among a single type of the application and different type of applications to the at least one host.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system to manage applications on multiple hosts in accordance with an exemplary embodiment of the present disclosure.

FIG. 2 illustrates an exemplary diagram of a network environment to manage applications on multiple hosts in accordance with an exemplary embodiment of the present disclosure.

FIG. 3 illustrates an exemplary system to manage applications on multiple hosts in accordance with an exemplary embodiment of the present disclosure.

FIG. 4 illustrates an exemplary method flow diagram to manage applications on multiple hosts in accordance with an exemplary embodiment of the present disclosure.

FIG. 5 illustrates a flow chart depicting a process of installation of applications on multiple hosts in accordance with an exemplary embodiment of the present disclosure.

FIG. 6 illustrates an architecture of a system to manage applications on multiple hosts in accordance with an exemplary embodiment of the present disclosure.

### DETAILED DESCRIPTION

Exemplary embodiments now will be described with reference to the accompanying drawings. The present application may, however, be embodied in many different forms and should not be construed as limited to the embodiments set forth herein; rather, these embodiments are provided so as to be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to herein as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skills in the art to which this application pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the present application may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

Currently, there is a notable absence of methods and systems that may offer automation and optimization in installation or modification of a vendor application (also referred to as an application) on multiple hosts. Currently, the installation of the vendor-based application on multiple hosts requires host-to-application mapping data along with installation parameters. Further, to install the applications on multiple hosts, the user needs to assign different names to the apps to function and for the installation over multiple hosts, such a process happens in a sequential manner which results in extended installation times and increased potential for manual errors. Thus, assigning names to the apps and providing apps to host mapping is a time-consuming and labour-intensive process.

The present disclosure solves the aforementioned problems by providing a method and system to manage applications on multiple hosts. In the present disclosure, the system may receive a request from a user to perform at least one task associated with at least one application. Further, the system may obtain from a server at least one software package and at least one parameter in response to the request. Further, the system may retrieve from the server an application to host mapping data based on a type of the at least one application in response to the request. Further, the system may provide the obtained at least one software package and the at least one parameter to at least one host in accordance with the retrieved application to host mapping data. Thereafter, the system may perform, at the at least one host, the at least one task using the obtained at least one software package and the at least one parameter.

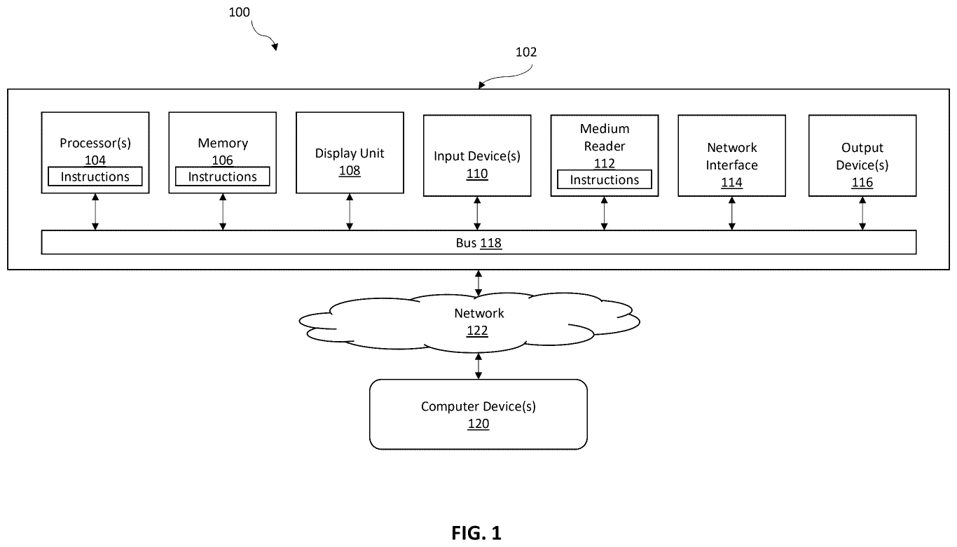

FIG. 1 is an exemplary system for use in accordance with the embodiments described herein. The system 100 is generally shown and may include a computer system 102 which is generally indicated. The term “computer system” may also be referred to herein as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include or be included within any one or more computers, servers, systems, communication networks, or cloud-based environments. The instructions may also be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set or multiple sets of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, high-density digital optical storage disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional or alternative input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may include but is not limited to, a speaker, an audio out, a video out, a remote-controlled output, a printer, or any combination thereof. Additionally, the term “Network interface” may also be referred to herein as “Communication interface” and such phrases/terms can be used interchangeably in the specifications.

Each of the components of the computer system 102 may be interconnected and communicate via a bus 118 or other communication link. As shown in FIG. 1, the components may be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, short-range wireless network, ZIGBEE®, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems to manage applications on multiple hosts.

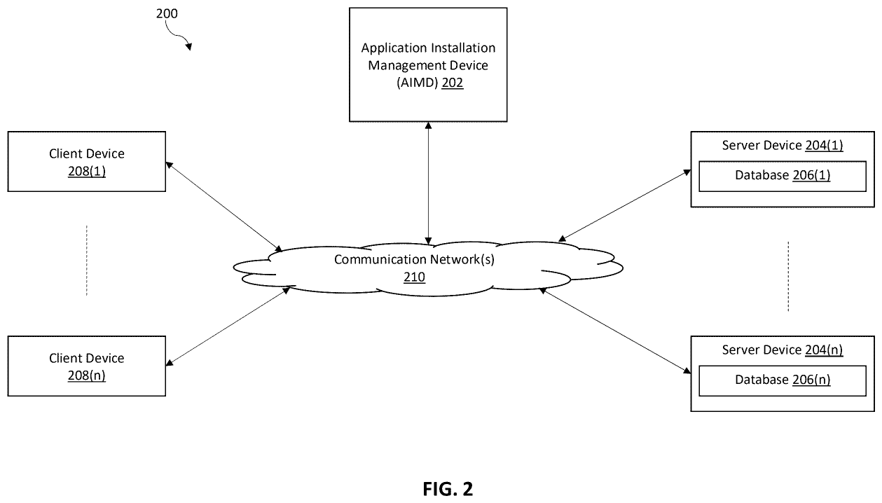

Referring to FIG. 2, a schematic of an exemplary network environment 200 to manage applications on multiple hosts is illustrated. In an exemplary embodiment, the method is executable on any networked computer platform, such as, for example, a personal computer (PC).

The method to manage applications on multiple hosts may be executed by an application installation management device (AIMD) 202. The AIMD 202 may be the same or similar to the computer system 102 as described with respect to FIG. 1. The AIMD 202 may store one or more applications that may include executable instructions that, when executed by the AIMD 202, cause the AIMD 202 to perform desired actions, such as to transmit, receive, or otherwise process network messages, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the AIMD 202 itself, may be located in the virtual server(s) running in a cloud-based computing environment rather than being tied to one or more specific physical network computing devices. Also, the application(s) may be running in one or more virtual machines (VMs) executing on the AIMD 202. Additionally, in one or more embodiments of this technology, virtual machine(s) running on the AIMD 202 may be managed or supervised by a hypervisor.

In the network environment 200 of FIG. 2, the AIMD 202 is coupled to a plurality of server devices 204(1)-204(n) that hosts a plurality of databases 206(1)-206(n), and also to a plurality of client devices 208(1)-208(n) via communication network(s) 210. A communication interface of the AIMD 202, such as the network interface 114 of the computer system 102 of FIG. 1, operatively couples and communicates between the AIMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AIMD 202, the server devices 204(1)-204(n), and/or the client devices 208(1)-208(n) may be coupled together via other topologies. Additionally, the network environment 200 may include other network devices such as, for example, one or more routers and/or switches, which are well known in the art and thus will not be described herein. This technology provides several advantages including methods, non-transitory computer-readable media, and AIMDs that efficiently implement the method to manage applications on multiple hosts.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, tele traffic in any suitable form (e.g., voice, modem, and the like), public switched telephone networks (PSTNs), ethernet-based packet data networks (PDNs), combinations thereof, and the like.

The AIMD 202 may be a standalone device or integrated with one or more other devices or apparatuses, such as one or more of the server devices 204(1)-204(n), for example. In one particular example, the AIMD 202 may include or be hosted by one of the server devices 204(1)-204(n), and other arrangements are also possible. Moreover, one or more of the devices of the AIMD 202 may be in the same or a different communication network including one or more public, private, or cloud-based networks.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the AIMD 202 via the communication network(s) 210 according to the hypertext transfer protocol (HTTP)-based and/or JAVASCRIPT® object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data associated with multiple applications, and multiple hosts.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within, for example, a cluster architecture, a peer-to-peer architecture, virtual machines, or within a cloud-based architecture. Thus, the technology disclosed herein is not to be construed as being limited to a single environment, and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the AIMD 202 via communication network(s) 210. Accordingly, the client devices 208(1)-208(n) may be, for example, mobile computing devices, desktop computing devices, laptop computing devices, tablet computing devices, or the like, that host chat, e-mail, or voice-to-text applications. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the AIMD 202 via the communication network(s) 210 in order to communicate user requests and information. The client devices 208(1)-208(n) may further include, among other features, a display device, such as a display unit or touchscreen, and/or an input device, such as a keyboard.

Although the exemplary network environment 200 with the AIMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AIMD 202, the server devices 204(1)-204(n), or the client devices 208(1)-208(n), for example, may be configured to operate as virtual instances on the same physical machine. In other words, one or more of the AIMD 202, the server devices 204(1)-204(n), or the client devices 208(1)-208(n) may operate on the same physical device rather than as separate devices communicating through communication network(s) 210. Additionally, there may be more or fewer AIMDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only tele traffic in any suitable form (e.g., voice and modem), wireless traffic networks, cellular traffic networks, packet data networks (PDNs), the Internet, intranets, and combinations thereof.

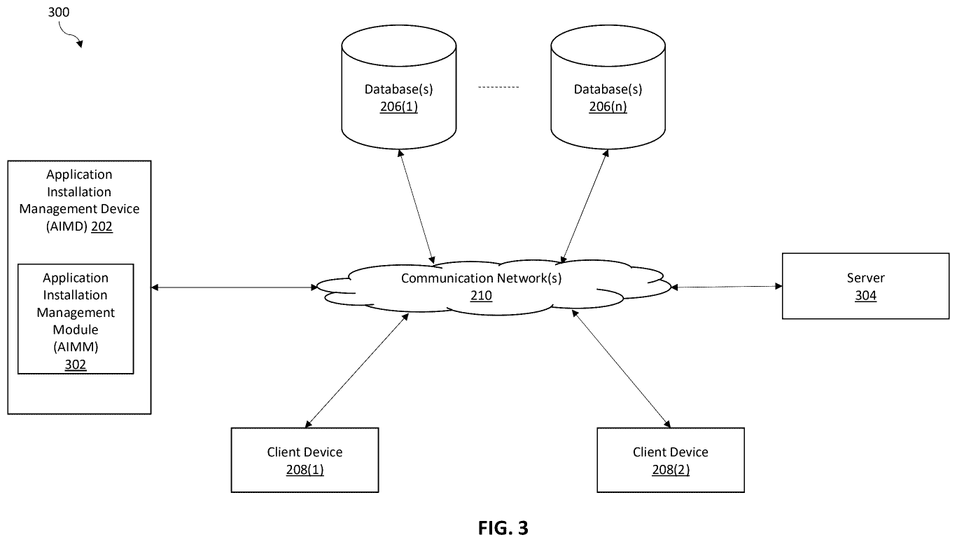

FIG. 3 illustrates a system diagram for implementing a method to manage applications on multiple hosts, in accordance with an exemplary embodiment.

As illustrated in FIG. 3, the system 300 may include an AIMD 202 within which an application installation management module (AIMM) 302 is embedded, a server 304, a database(s) 206(1) . . . 206(n), a plurality of client devices 208(1) . . . 208(2), and a communication network(s) 210.

According to exemplary embodiments, the AIMD 202 including the AIMM 302 may be connected to the server 304, and the database(s) 206(1) . . . 206(n) via the communication network(s) 210, but the disclosure is not limited thereto. The AIMD 202 may also be connected to the plurality of client devices 208(1) . . . 208(2) via the communication network 210, but the disclosure is not limited thereto. The database(s) 206(1) . . . 206(n) may include a repository/database.

In an embodiment, the AIMD 202 is described and shown in FIG. 3 as including the AIMM 302, although it may include other rules, policies, modules, databases, or applications, for example. As will be described below, the AIMM 302 is configured to implement a method to manage applications on multiple hosts.

An exemplary system 300 for implementing a mechanism to manage applications on multiple hosts by utilizing the network environment of FIG. 2 is shown as being executed in FIG. 3. Specifically, a first client device 208(1) and a second client device 208(2) are illustrated as being in communication with the AIMD 202. In this regard, the first client device 208(1) and the second client device 208(2) may be “clients” of the AIMD 202 and are described herein as such. Nevertheless, it is to be known and understood that the first client device 208(1) and/or the second client device 208(2) need not necessarily be “clients” of the AIMD 202, or any entity described in association therewith herein. Any additional or alternative relationship may exist between either or both of the first client device 208(1) and the second client device 208(2) and the AIMD 202, or no relationship may exist.

Further, the AIMD 202 is illustrated as being able to access one or more databases 206(1) . . . 206(n). The AIMM 302 may be configured to access these repositories/databases for implementing a method to manage applications on multiple hosts. In some embodiment, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the AIMD 202 via broadband or cellular communication. These embodiments are merely exemplary and are not limiting or exhaustive.

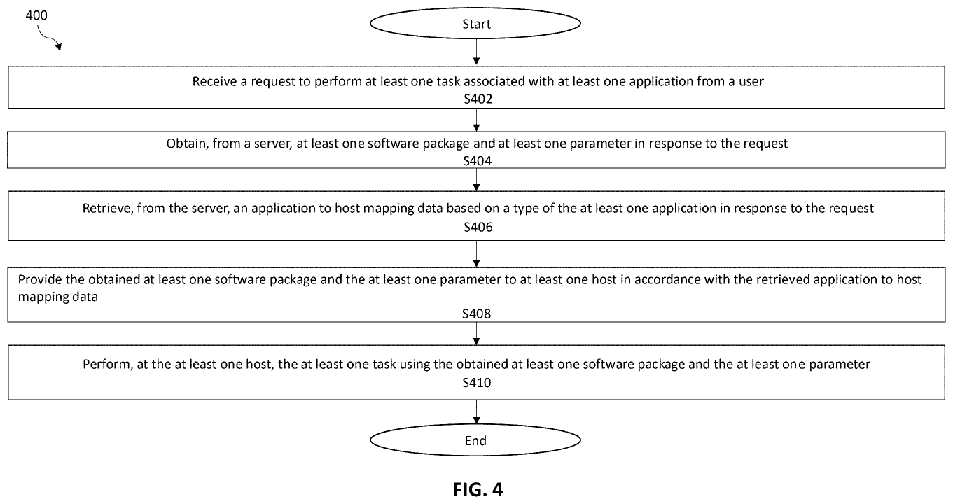

Referring to FIG. 4, an exemplary method 400 is shown to manage applications on multiple hosts in accordance with an exemplary implementation.

As shown in FIG. 4, the method 400 begins following a need to perform a parallel installation of a single type of application or multiple types of applications on multiple hosts to reduce installation time. The method 400 is implemented by at least one processor 104.

At step S402, the method 400 includes receiving, by the at least one processor 104, a request to perform at least one task associated with at least one application from a user. The request may include an application installation request, an application modification request, or an application uninstallation request. The at least one task may include an installation of the at least one application, a modification of the at least one application, and an uninstallation of the at least one application at a plurality of hosts.

The term “application” herein may correspond to a software program or a tool that is designed to receive input from the user, process the input, and provide output to the user.

As used herein, application installation refers to the process of placing and setting up an application on at least one host (e.g., a server).

As used herein, application modification may involve altering an existing application to change its functionality, appearance, or performance. This may include updating the application, changing its settings, or applying patches and enhancements.

As used herein, uninstallation of the application may refer to the process of removing the application from the at least one host.

In an exemplary implementation, the user may raise the request over a user interface (UI) of an application installation management platform to install the application on at least one host or a plurality of hosts.

It would be appreciated by the person skilled in the art that the aim here is to create a system that implements parallel installation of at least one on multiple hosts using an application to host mapping data.

At step S404, the method includes obtaining, by the at least one processor 104 from a server, at least one software package and at least one parameter in response to the request.

As used herein, a software package may be a bundled set of files and instructions necessary for the installation, configuration, and execution of a software on a computing device. The software package may usually contain the application code, libraries, and other resources required for the software to operate.

In an implementation, the server may include the at least one software package along with corresponding file details. Further, the server may include the plurality of parameters required to perform the at least one task. The software packages may be utilized for installation of the at least one application.

As used herein, the plurality of parameters may include application installation parameters, application modification parameters, and application uninstallation parameters. For instance, the application installation parameters may be required to install the at least one application on a plurality of hosts. The examples of application installation parameters may include, but are not limited to, an application name, an application version, an application type, a path, a log location, and a directory associated with the installation of the application. The examples of application modification parameters may include, but are not limited to, an application status check and an installation directory to match with a backup location. The examples of application uninstallation parameters include but are not limited to, application name, a force kill command, and an application backup location. In an exemplary implementation, the application installation parameters, the application modification parameters, and the application uninstallation parameters are provided below in a tabular format.

| | Application | Application |
|---|---|---|
| Application installation | modification | uninstallation |
| parameters | parameters | parameters |
| AppName = confserv | AppStatus_Check = | AppName = confserv |
| | Running or Stop | |
| AppVersion = 8.1.3 | Installation | Force Kill |
| | Directory = /ect/install | Command = /stop.sh |
| AppTyp = Config | Modify | Backup |
| | Parameters = $env | Location = /etc/backup |

In an exemplary implementation, the method may include fetching, by the at least one processor 104, at least one software package out of the plurality of software packages and the at least one parameter from at least one repository belonging to an organization. The server may be connected with the at least one processor 104 via a communication network. The communication network may be an internet-based network.

At step S406, the method may include retrieving, by the at least one processor 104 from the server, an application to host mapping data based on a type of the at least one application in response to the request.

The application to host mapping data may correspond to the mapping of one of a single type of the application or different types of applications to the at least one host (or plurality of hosts). For example, as part of the infrastructure setup, installation of multiple types of applications is required, as each serves different purposes. The type of application may depend on several factors such as, but not limited to, target audience, required functionality, and a platform on which the application will be used. The types of applications may include, but are not limited to, orchestration applications, routing applications, and reporting applications. The orchestration applications help orchestrate interactions, ensuring that various components and services work together seamlessly. The routing applications are responsible for routing interactions, directing data, and requests to appropriate destinations. The reporting applications may be used for reporting purposes, providing insights and analytics based on collected data.

Further, installation of applications takes reference from the application to host mapping data. Hence, installation of the application(s) may be performed as per the application to host mapping data, which eliminates a need for the manual intervention in pointing the specific application to a respective host.

At step S408, the method includes providing, by the at least one processor 104, the obtained at least one software package and the at least one parameter to at least one host in accordance with the retrieved application to host mapping data.

At step S410, the method includes performing, by the at least one processor 104 at the at least one host, the at least one task using the obtained at least one software package and the at least one parameter.

In an exemplary implementation of the present disclosure, the at least one task corresponds to an installation of the at least one application at the at least one host (or the plurality of hosts) when the request is received for the installation of the at least one application. In another exemplary implementation of the present disclosure, the at least one task corresponds to a modification of the at least one application at the at least one host (or the plurality of hosts) when the request is received for the modification of the at least one application. In yet another exemplary implementation of the present disclosure, the at least one task corresponds to an uninstallation of the at least one application at the at least one host (or the plurality of hosts) when the request is received for the uninstallation of the at least one application. This way the application(s) may be parallelly installed or modified or uninstalled at the plurality of hosts.

In an example, when the request corresponds to an application installation request, the at least one software package out of the plurality of software packages and the at least one application installation parameter are provided to the at least one host for installation of such application on the at least one host.

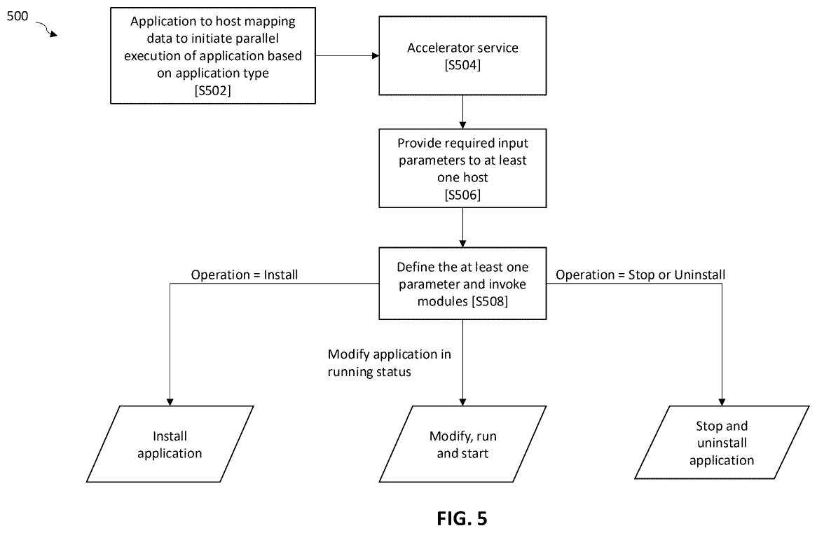

FIG. 5 illustrates a flow chart depicting a process of installation of applications on at least one host in accordance with an exemplary implementation of the present disclosure. As illustrated in FIG. 5, the process flow 500 begins at step S502 by receiving an application to host mapping data, from a server or an artifactory (e.g., JFROG®), in response to a request received to perform at least one task associated with at least one application, from a user. The request may include an application installation request, an application modification request, or an application uninstall request. At step S504, an accelerator service (e.g., ANSIBLE®) or automaton-as-a service (AAAS) tools utilizes the application to host mapping data to initiate parallel execution of the application on multiple hosts based on an application type. The server may include the application to host mapping data, a plurality of parameters, and a plurality of software packages (also referred to as software installation packages). The plurality of parameters may include, but are not limited to, application installation parameters, application modification parameters, or application uninstallation parameters. In an exemplary implementation, the application installation parameters may include a path, a log location, and a directory required for the installation of the at least one application. At step S506, the accelerator service fetches at least one software package and the at least one parameter and provides the required at least one input parameter along with the at least one software package to the respective at least one host in accordance with the application to host mapping data.

At step S508, the accelerator service may define the at least one parameter and invokes modules or calls to one of the subscripts for the at least one task. The at least one task may include the installation of the application, the modification of the application, and the uninstallation of the application. In an exemplary embodiment, the accelerator service verifies if the application already exists on the respective host or not and performs actions accordingly (e.g., kill installation of the application where it is already installed). If the at least one task corresponds to the installation of the application, then the accelerator service is configured to execute installation of the application on the respective host. In yet another exemplary embodiment, if the at least one task corresponds to the modification of the application, then the accelerator service is configured to modify the running application and then restart the application. In yet another exemplary embodiment, if the at least one task corresponds to the uninstallation of the application, then the accelerator service causes uninstallation of the application from the respective host based on the application to host mapping data. This way the parallel execution of the application on multiple hosts is performed.

It would be appreciated by the person skilled in the art that the disclosed method offers a full-circle, adaptable, and intelligent solution for implementing a method for accelerating installation of applications on multiple hosts based on the application to host mapping data.

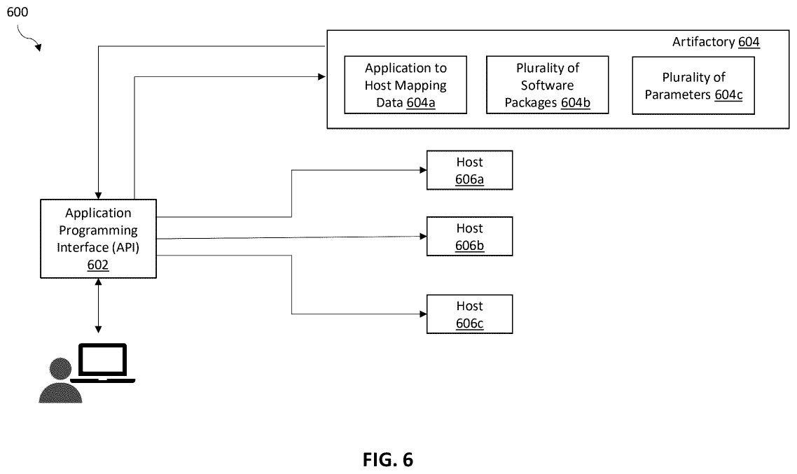

FIG. 6 illustrates an architecture of a system to manage applications on multiple hosts in accordance with an exemplary implementation of the present disclosure. As illustrated in FIG. 6, the process flow 600 begins with receiving a request over an application programming interface (API) 602 (e.g., accelerator service) to perform at least one task associated with at least one application from a user. The user may raise the request by using a computing device. The computing device may be selected from, but is not limited to, a laptop, a smartphone, and a tablet. The request may include an application installation request, an application modification request, and an application uninstallation request. The at least one task may include the installation of the at least one application, the modification of the at least one application, and the uninstallation of the at least one application on a plurality of hosts 606a, 606b, and 6060c.

Further, the API 602 obtains at least one software package and at least one parameter out of a plurality of software packages 604b and a plurality of parameters 604c from an artifactory (e.g., JFROG®) 604 in response to the request. The artifactory 604 may include but is not limited to application to host mapping data 604a, the plurality of software packages 604b, and the plurality of parameters 604c. Further, the API 602 utilizes the application to host mapping data 604a to perform parallel execution of the at least one application on the plurality of hosts 606a, 606b, and 6060c. The API 602 provides at least one software package and the at least one parameter out of the plurality of software packages 604b and the plurality of parameters 604c to the plurality of hosts (606a, 606b, and 606c) in accordance with the application to host mapping data 604a. Thus, the application is parallelly installed on multiple hosts 606a, 606b, and 6060c in accordance with the application to host mapping data 604a. The API 602 performs the at least one task (e.g., the installation of the application, the modification of the application, and the uninstallation of the application) using the plurality of software packages 604b and the plurality of parameters 604c.

In an example, if the at least one application already exists on the respective hosts, then the API 602 stops the installation of the at least one application. In an example, if the at least one task corresponds to the modification of the at least one application then the required files of the application get modified. It is to be noted that files required for such modification are downloaded from the artifactory 604 by the API 602. In another example, if the at least one task corresponds to the uninstallation of the at least one application then the at least one application is uninstalled or removed from respective hosts in accordance with the application to host mapping data 604a.

The present disclosure provides numerous advantages as given below. The present disclosure provides a method to manage applications on multiple hosts. The method disclosed in the present disclosure delivers automated installation of a single application type on multiple hosts and multiple application type on multiple hosts for different applications by taking the parallel installation approach, thus reducing the application installation time or application modification time. The method enhances overall efficiency and management of different applications on multiple hosts. The disclosed method enhances overall efficiency and management of software products provided from different vendors.

Although the present application has been described with reference to several exemplary embodiments, it is understood that the words that have been used are words of description and illustration, rather than words of limitation. Changes may be made within the purview of the appended claims, as presently stated, and as amended, without departing from the scope and spirit of the present application in its aspects. Although the present application has been described with reference to particular means, materials, and embodiments, the present application is not intended to be limited to the particulars disclosed; rather, the present application extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to manage applications on multiple hosts is disclosed. The instructions include executable code which, when executed by a processor 104, may cause the processor 104 to receive a request from a user to perform at least one task associated with at least one application; obtain from a server, at least a plurality of software packages and a plurality of parameters in response to the request; retrieve from the server, an application to host mapping data based on a type of the at least one application in response to the request; provide, at least the plurality of software packages and the plurality of parameters to a plurality of hosts in accordance with the application to host mapping data; and perform, at the plurality of hosts, the at least one task using at least the plurality of software packages and the plurality of parameters.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description with each claim standing on its own as defining separately claimed subject matter.

The above-disclosed subject matter is to be considered illustrative and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method to manage applications on multiple hosts, the method being implemented by at least one processor, the method comprising:
receiving, by the at least one processor, a request to perform at least one task associated with at least one application from a user;
obtaining, by the at least one processor from a server, at least one software package and at least one parameter in response to the request;
retrieving, by the at least one processor from the server, an application to host mapping data based on a type of the at least one application in response to the request;
providing, by the at least one processor, the obtained at least one software package and the least one parameter to at least one host in accordance with the retrieved application to host mapping data; and
performing, by the at least one processor at the at least one host, the at least one task using the obtained at least one software package and the at least one parameter.

2. The method as claimed in claim 1, wherein the at least one task corresponds to an installation of the at least one application at the at least one host when the request is received for the installation of the at least one application.

3. The method as claimed in claim 1, wherein the at least one task corresponds to a modification of the at least one application at the at least one host when the request is received for the modification of the at least one application.

4. The method as claimed in claim 1, wherein the at least one task corresponds to an uninstallation of the at least one application at the at least one host when the request is received for the uninstallation of the at least one application.

5. The method as claimed in the claim 1, wherein the at least one parameter comprises at least one from among application installation parameters, application modification parameters, and application uninstallation parameters.

6. The method as claimed in claim 1, wherein the application to host mapping data corresponds to the mapping of at least one from among a single type of the application and different type of applications to the at least one host.

7. A computing device configured to manage applications on multiple hosts, the computing device comprising:
a processor;
a memory; and
a communication interface coupled to each of the processor and the memory,
wherein the processor is configured to:
receive a request from a user to perform at least one task associated with at least one application;
obtain, from a server, at least one software package and at least one parameter in response to the request;
retrieve, from the server, an application to host mapping data based on a type of the at least one application in response to the request;
provide the obtained at least one software package and the at least one parameter to at least one host in accordance with the retrieved application to host mapping data; and
perform, at the at least one host, the at least one task using the obtained at least one software package and the at least one parameter.

8. The computing device as claimed in claim 7, wherein the at least one task corresponds to an installation of the at least one application at the at least one host when the request is received for installation of the at least one application.

9. The computing device as claimed in claim 7, wherein the at least one task corresponds to a modification of the at least one application at the at least one host when the request is received for the modification of the at least one application.

10. The computing device as claimed in claim 7, wherein the at least one task corresponds to an uninstallation of the at least one application at the at least one host when the request is received for the uninstallation of the at least one application.

11. The computing device as claimed in the claim 7, wherein the at least one parameter comprises at least one from among application installation parameters, application modification parameters, and application uninstallation parameters.

12. The computing device as claimed in claim 7, wherein the application to host mapping data corresponds to the mapping of at least one from among a single type of the application and different type of applications to the at least one host.

13. A non-transitory computer readable storage medium storing instructions to manage applications on multiple hosts, the storage medium comprising executable code which, when executed by a processor, causes the processor to:
receive a request from a user to perform at least one task associated with at least one application;
obtain, from a server, at least one software package and at least one parameter in response to the request;
retrieve, from the server, an application to host mapping data based on a type of the at least one application in response to the request;
provide the obtained at least one software package and the at least one parameter to at least one host in accordance with the retrieved application to host mapping data; and
perform, at the at least one host, the at least one task using the obtained at least one software package and the at least one parameter.

14. The storage medium as claimed in claim 13, wherein the at least one task corresponds to an installation of the at least one application at the at least one host when the request is received for installation of the at least one application.

15. The storage medium as claimed in claim 13, wherein the at least one task corresponds to a modification of the at least one application at the at least one host when the request is received for the modification of the at least one application.

16. The storage medium as claimed in claim 13, wherein the at least one task corresponds to an uninstallation of the at least one application at the at least one host when the request is received for the uninstallation of the at least one application.

17. The storage medium as claimed in claim 13, wherein the at least one parameter comprises at least one from among application installation parameters, application modification parameters, and application uninstallation parameters.

18. The storage medium as claimed in claim 13, wherein the application to host mapping data corresponds to the mapping of at least one from among a single type of the application and different type of applications to the at least one host.
